(19) United States
(12) Patent Application Publication
(10) Pub. No.: US 2019/0195633 A1
(43) Pub. Date: Jun. 27, 2019

(54) INFORMATION PROCESSING DEVICE AND INFORMATION PROCESSING METHOD

(71) Applicant: Toyota Jidosha Kabushiki Kaisha, Toyota-shi Aichi-ken (JP)

(72) Inventors: Tomohito Matsuoka, Nagoya-shi Aichi-ken (JP); Seiichi Tsunoda, Nisshin-shi Aichi-ken (JP); Jiro Goto, Seto-shi Aichi-ken (JP); Masayuki Yamada, Chofu-shi Tokyo-to (JP); Yasutaka Eto, Okazaki-shi Aichi-ken (JP); Keima Fukunaga, Toyota-shi Aichi-ken (JP); Kinya Tagawa, Minato-ku Tokyo-to (JP); Yasuhiro Sasaki, Minato-ku Tokyo-to (JP); Sho Tanaka, Minato-ku Tokyo-to (JP); Yuki Shinohara, Minato-ku Tokyo-to (JP)

(21) Appl. No.: 16/224,089

(22) Filed: Dec. 18, 2018

(30) Foreign Application Priority Data
Dec. 26, 2017 (JP) 2017-250048

(51) Int. Cl. G01C 21/20; G01C 21/34

(52) U.S. Cl. CPC G01C 21/20; G01C 21/3453

(57) ABSTRACT

An acquisition unit in an information processing device acquires a traveling time of a vehicle from a place of departure to a destination, and a period of time required for a task performed by a user. A derivation unit derives a period of time required for a remaining task in accordance with the period of time required for the task acquired by the acquisition unit and a period of time that the user performed the task. An output unit outputs a suggestion, for departure in the vehicle, when the period of time required for the remaining task derived by the derivation unit and the traveling time acquired by the acquisition unit meet a predetermined relationship.

### CROSS-REFERENCES TO RELATED APPLICATION

This application claims priority to Japanese Patent Application No. 2017-250048 filed on Dec. 26, 2017, incorporated herein by reference in its entirety.

### BACKGROUND

### 1. Technical Field

The present disclosure relates to an information processing device and an information processing method for processing information.

### 2. Description of Related Art

Mobile office built by carrying a desk, a chair, a bookshelf, office automation equipment, communication equipment, etc. on automobiles are known see, for example, JP09-183334). The passenger of a mobile office can get the paperwork done: while the vehicle is traveling.

Where the above technology is used to allow a passenger to get the paperwork done while the vehicle is traveling toward a destination and deliver a completed document, etc. to the destination, a prolonged time may elapse since the completion of the paperwork until the arrival at the destination and may be consumed wastefully.

### SUMMARY

The embodiments address the above-described issue, and a general purpose thereof is to provide an information processing device and an information processing method capable of reducing the time that elapses since the completion of a task performed by a user in a vehicle until the arrival at a destination.

An information processing device according to an embodiment includes: an acquisition unit configured to acquire a traveling time of a vehicle from a place of departure to a destination, and a period of time required for a task performed by a user; a derivation unit configured to derive a period of time required for a remaining task in accordance with the period of time required for the task acquired by the acquisition unit and a period of time that the user performed the task; and an output unit configured to output a suggestion for departure in the vehicle, when the period of time required for the remaining task derived by the derivation unit and the traveling time acquired by the acquisition unit meet a predetermined relationship.

According to this embodiment, a suggestion for departure in the vehicle is output when the period of time required for the remaining task and the traveling time meet a predetermined relationship. It is therefore possible to cause the vehicle to depart toward the destination at an appropriate point in time and allow the user to perform the remaining task in the vehicle. Accordingly, the time between completion of the task and the arrival at the destination is reduced.

The output unit may output a suggestion for departure when the period of time required for the remaining task becomes shorter than the traveling time.

The acquisition unit may acquire the traveling time from the place of departure to the destination by way of a transit site necessary for the remaining task.

The acquisition unit may acquire a desired time of arrival at the destination, and the output unit may output a task start time for the task to be completed at the desired time of arrival, based on the period of time required for the task.

Another embodiment relates to an information processing method. The method includes: acquiring a traveling time of a vehicle from a place of departure to a destination, and a period of time required for a task performed by a user; deriving a period of time required for a remaining task in accordance with the period of time required for the task acquired and a period of time that the user performed the task; and outputting a suggestion for departure in the vehicle, when the period of time required; for the remaining task derived and the traveling time acquired meet a predetermined relationship.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a block diagram of a vehicle system according to an embodiment;

FIG. 2 is a block diagram showing a configuration of the server device of FIG. 1;

FIG. 3 is a block diagram showing a configuration of the vehicle-mounted device of FIG. 1; and

FIG. 4 shows a traveling route of the vehicle of FIG. 1 from, a user's office to a destination.

### DETAILED DESCRIPTION

An embodiment will now be described. The embodiment is illustrative and is not intended to be limiting.

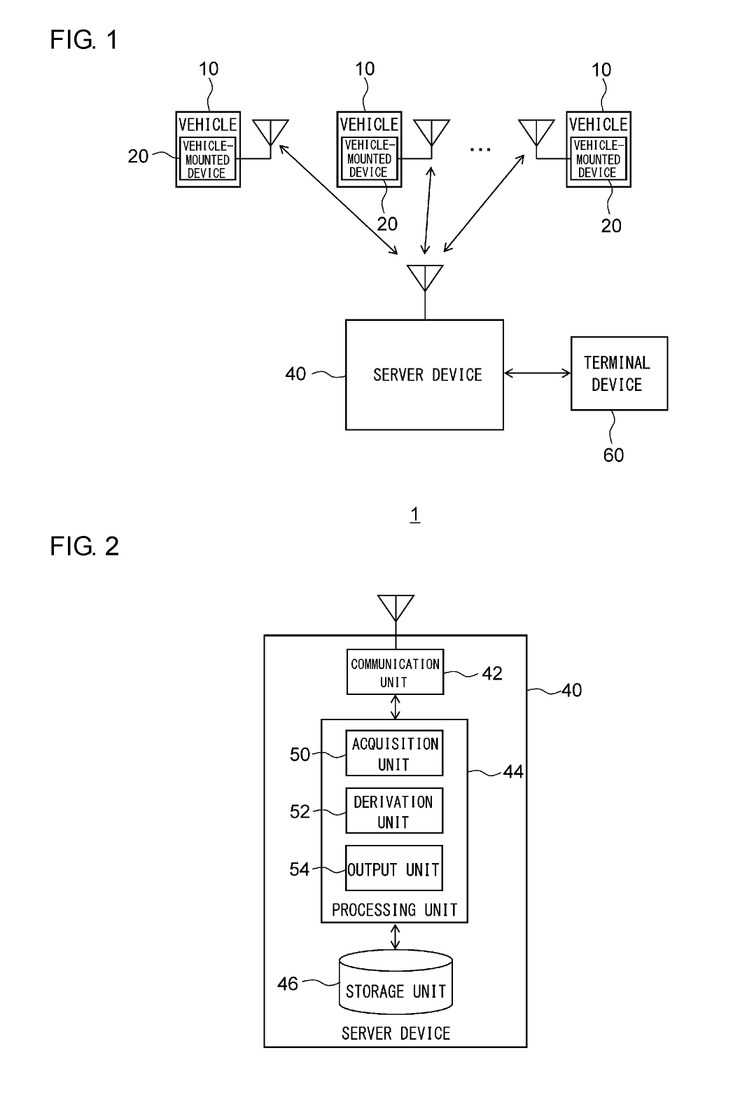

FIG. 1 is a block diagram of a vehicle system 1 according to an embodiment. The vehicle system 1 includes a plurality of vehicle-mounted devices 20, a server device 40, and a terminal device 60. FIG. 1 shows three vehicle-mounted devices 20 of a plurality of vehicle-mounted devices 20.

The vehicle-mounted device 20 is carried on the vehicle 10. The vehicle 10 is an automatically-driven car, and the user in the car can perform a task while the vehicle 10 is traveling. The vehicle 10 is equipped with facilities to perform tasks. The vehicle 10 is exemplified by, but not limited to, an electric car. The task is exemplified by, but not limited to, assembly of a product, preparation of food and drink, drafting of a manuscript, research, CAD design, programming, kimono dressing, etc. A teleconference may be held in the vehicle 10 along with assembly of a product.

It is assumed in the embodiment that, after starting the task outside the vehicle 10 (e.g., at an office where the user is working), the user leaves the office and gets in the vehicle 10 before the task is completed, performs the remaining task in the vehicle 10 traveling from the office to the destination, and delivers the completed product by performing a task sequence to the destination.

The vehicle-mounted device 20 communicates wirelessly with the server device 40. The embodiment is non-limiting as to the standard for wireless communication. For example, wireless LAN, 3G (third-generation mobile communication system), 4G fourth-generation mobile communication system), or 5G (fifth-generation mobile communication system) is covered. The vehicle-mounted device 20 may communicate wirelessly with the server device 40 via a base station (not shown).

For example, the server device 40 is placed at an office or the like where the user is working. The server device 40 functions as an information processing device.

The terminal device 60 is exemplified by a personal computer or a smartphone and can communicate with the server device 40 by wire or wirelessly. The server device 40 may additionally be provided with the function of the terminal device 60. Information on the user's task schedule and the user's task situation is input to the terminal device 60 by, for example, the user operation. The terminal device 60 outputs the input information to the server device 40.

The user's task schedule includes information on a period of time required for a task performed by the user, one or more transit sites necessary for the task, the site where the product obtained as a result of the task is delivered, and the time and date of delivery, which is the desired time of arrival at the sate of delivery.

Transit sites necessary for the task differ from one task to another. For example, a transit site may be a shop or an office. In the case of assembly of a product, the transit site is exemplified by a site where a component necessary to assemble the product is available. In the case of preparation of food and drink, the transit site is exemplified by a site where goods necessary to prepare the food and drink is available. In the case of drafting of a manuscript, the transit site is exemplified by a site where information necessary to draft the manuscript is available. In the case of research, the the transit site is exemplified by a site where goods, information, and/or staff necessary for the research is available.

In the case of CAD design, the transit site is exemplified by a site where information necessary for the design, etc. is available. In the case of programming, the transit site is exemplified by a site where information necessary for the programming is available. In the case of kimono dressing, the transit site is exemplified by a site where a kimono, an obi belt, accessories, etc. necessary for kimono dressing are available. In case there is a constraint on the sequence of procurement of goods for the purpose of performing the task efficiently, information on the sequence of visits may be appended to the transit site.

In the case of assembly of a product, drafting of a manuscript, research, CAD design, and programming, the transit site(s) may include an office where a supervisor who authorizes the task is working. In this case, the user can have the task authorized by a signature or a seal of the supervisor on the document at the transit site.

The information on the user's task situation is information indicating that the user has started the task at an office or that the user has suspended the task.

FIG. 2 is a block diagram: showing a configuration of the server device 40 of FIG. 1. The server device 40 includes a communication unit 42, a processing unit 44, and a storage unit 46. The processing unit 44 includes an acquisition unit 50, a derivation unit 52, and an output unit 54.

The storage unit 46 stores information on the position of the user's office and a map. The acquisition unit 50 acquires the user's task schedule and the information on the user's task situation from the terminal device 60. The acquisition unit 50 acquires a traveling route of the vehicle 10 from the user's office that is the starting point, to the site of delivery that is the destination, via the transit site(s) and also acquires the traveling time from the starting point to the destination via the transit site(s). For example, the acquisition unit 50 acquires the shortest traveling route. It is assumed that the traveling time is shorter than the period of time required for the task. When the information on the sequence of visits is appended to the transit site(s), the acquisition unit 50 acquires the traveling route and the traveling time by way of the transit site(s) visited in that sequence. For acquisition of the traveling route and the traveling time, a route search technology may be used. The acquisition unit 50 causes the storage unit 46 to store these items of information.

The derivation unit 52 derives the task start time for the task to be completed at the desired time of arrival, based on the period of time required for the task acquired by the acquisition unit 50. More specifically, the derivation unit 52 derives, as the task start time, the time that goes back from the desired time of arrival by the period of time required for the task.

Based on the desired time of arrival and the traveling time acquired by the acquisition unit 50, the derivation unit 52 derives the departure time that should be observed to arrive at the destination at the desired time of arrival.

The derivation unit 52 derives a period of time that the user performed the task outside the vehicle 10, based on the information on the user's task situation acquired by the acquisition unit 50. The derivation unit 52 derives a period of time required for the remaining task in accordance with the period of time required for the task acquired by the acquisition unit 50 and the period of time that the user performed the task outside the vehicle 10. More specifically, the derivation unit 52 derives the period of time required for the remaining task by subtracting the period of time that the user performed the task outside the vehicle 10 from the period of time required for the task.

The output, unit 54 outputs the task start time and the departure time derived by the derivation unit 52 to the terminal device 60. When the period of time required for the remaining task derived by the derivation unit 52 and the traveling time acquired by the acquisition unit 50 meet a predetermined relationship, the output unit 54 outputs a suggestion for departure in the vehicle 10 to the terminal device 60. More specifically, the output unit 54 outputs the suggestion for departure in the vehicle 10 when the period of time required for the remaining task becomes shorter than the traveling time. The output unit 54 may output a suggestion for departure in the vehicle 10 when the period of time required for the remaining task becomes substantially equal to the traveling time.

Upon receiving the task start time and the departure time, the terminal device 60 notifies the user of the task start time and the departure time by means of a character, an image, sound, etc. When the departure time draws near, the the terminal device 60 notifies the user that the departure time is near. Upon receiving a suggestion for departure in the vehicle 10, the terminal device 60 notifies the user of the suggestion by way of a character, an image, a sound, etc.

The communication unit 42 communicates wirelessly with a plurality of vehicle-mounted devices 20. The communication unit 42 transmits information on a place of departure, transit site(s), a destination, and a traveling route to the target vehicle 10. Information identifying the vehicle 10 at the destination of transmission is appended to these items of information.

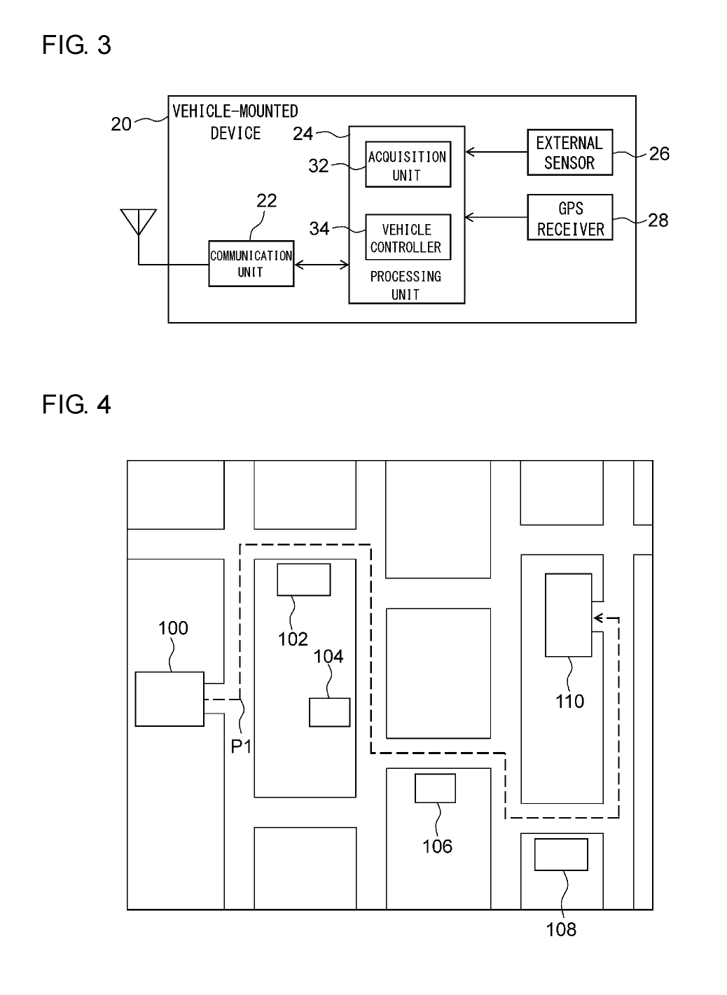

FIG. 3 is a block diagram showing a configuration of the vehicle-mounted device 20 of FIG. 1. The vehicle-mounted device 20 includes a communication unit 22, a processing unit 24, an external sensor 26, and a GPS receiver 28. The processing unit 24 includes an acquisition unit 32 and a vehicle controller 34.

The communication unit 22 communicates wirelessly with the service device 40. When the information on the place of departure, the transit site, the destination, and the traveling route is transmitted from the server 24 to the host vehicle, the communication unit 22 receives these items of information.

The external sensor 26 periodically detects information on obstacles such as a pedestrian around the host vehicle and outputs a result of detection to the processing unit 24. For example, the external sensor 26 includes at least one of a camera, LIDAR (Laser Imaging Detection and Ranging), and a radar.

The GPS receiver 28 receives a signal from a GPS satellite and calculates the position and orientation of the host vehicle. The position includes the latitude and the longitude. The GPS receiver 28 outputs information on the position and orientation of the host vehicle to the processing unit 24.

The acquisition unit 32 acquires the information on the place of departure, the transit site, the destination, and the traveling route received by the communication unit 22.

When the user gets in the host vehicle, the vehicle controller 34 causes the host vehicle to travel automatically along the traveling route by controlling the drive motor, the braking device, the steering device, etc. (not shown) in accordance with the information acquired by the acquisition unit 32 and the information on the position and orientation of the host vehicle. When it is determined that there are no obstacles in the direction of travel by referring to information on obstacles around the host vehicle detected by the external sensor 26, the vehicle controller 34 causes the host vehicle to move. For control, automatic driving technology may be used.

When the host vehicle arrives at the transit site acquired by the acquisition unit 32, the vehicle controller 34 temporarily stops the host vehicle. The user of the vehicle 10 temporarily stopped receives goods, etc. from the shop employee or the worker at the transit site.

When goods, etc. have been received at the transit site, the vehicle controller 34 causes the host vehicle to travel to the next transit site of the destination. When the host vehicle arrives at the position of the destination acquired by the acquisition unit 32, the vehicle controller causes the host vehicle to stop.

The features are implemented in hardware such as a CPU, a memory, or other LSI's, of any computer and in software such as a program loaded into a memory. The figure depicts functional blocks implemented by the cooperation of these elements. Therefore, it will be understood by those skilled in the art that the functional blocks may be implemented in a variety of manners by hardware only, software only, or by a combination of hardware and software.

A description will now be given of an overall operation of the vehicle system 1 having the above configuration. FIG. 4 shows a traveling route P1 of the vehicle 10 of FIG. 1 from a user's office 100 to a destination 110. The traveling route Pi leads from the office 100 to the destination 110 via transit sites 102-108. Assembly of a product will be described as an example of the task performed by the user. The transit point 102 is a sales outlet where the first component is available. The transit point 104 is a sales outlet where the second component is available. The transit point 106 is a sales outlet where the third component is available. The transit point 108 is a sales outlet where the fourth component is available. The first through fourth components are not available in the office 100 and differ, for example, depending on the customer of the product.

The user, etc. inputs a task schedule in the terminal device 60 in advance. The vehicle 100 stands by in front of the office 100.

The terminal device 60 notifies the user of the task start time when the task should be started and the departure time when the user should depart in the vehicle 10. The user thus notified: starts the task in the office 100 before the task start time, for example. The user makes an input in the terminal device 60 to indicate that the task is started. When the task is suspended, after it is started, the user makes an input in the terminal device 60 to indicate that the task is suspended. As the period of time required for the remaining task is decreased until the period of time required for the remaining task is shorter than the traveling time, the terminal device 60 gives a suggestion for departure in the vehicle 10 to the user. This allows the user to recognize that the time for departure in the vehicle 10 has arrived.

If it is OK to arrive at the destination before the time and date of delivery, the user may depart in the vehicle 10 immediately after the notification. Alternatively, when it is necessary to arrive at the destination substantially at the time and date of delivery, the user may suspend the task and perform a different task until the departure time. In this case, the terminal device 60 notifies the user that the departure time is near when the departure time draws near. Therefore, the user can depart in the vehicle 10 at a proper point in time.

In a situation where the user starts the task in the office 100 substantially at the task start time, the terminal device 60 notifies the user that the departure time is near when the departure time draws near. The period of time required for the remaining task becomes shorter than the traveling time, and, when the terminal device 60 gives a suggestion for departure in the vehicle 10 to the user, the departure time will have arrived substantially. Therefore, the user can depart in the vehicle 10 at a proper point of time.

When the user gets in the vehicle 10, the vehicle 10 starts at the office 100 and travels along the traveling route P1. While the vehicle 100 is traveling, the user performs the remaining task by using the facilities in the vehicle 10. The vehicle 10 stops at the transit site 102, here, the user in the vehicle 10 receives the first component. Subsequently, the vehicle 10 travels along the traveling route PI and stops at the transit site 104. Here, the user in the vehicle 10 receives the second component.

Similarly, the user in the vehicle 10 receives the third component at the transit site 106 and receives the fourth component at the transit site 108. The user assembles the product by using the first through fourth components. Subsequently, the vehicle 10 travels along the traveling route P1 and arrives at the destination lie before the time and date of delivery or substantially at the date and time of delivery. At the destination 110, the user of the vehicle 10 delivers the completed product to the customer.

Thus, according to this embodiment, a suggestion for departure in the vehicle 10 is output when the period of time required for the remaining task becomes shorter than the traveling time. It is therefore possible to cause the vehicle 10 to depart toward the destination at an appropriate point in time and allow the user to perform the remaining task in the vehicle 10. Accordingly, the time that elapses since the user completes the task in the vehicle 10 until the user arrives at the destination is reduced. The embodiment further reduces the likelihood that the task is not completed until the vehicle 10 arrives at the destination.

Since the transit site necessary for the task is visited during the travel to the destination, goods, etc. necessary for the remaining task are obtained at the transit site and the efficiency of performing the task until the arrival at the destination is increased.

Still further, the output unit 54 outputs the task start time for the task to be completed at the desired time of arrival so that the user can know when the task should be started in the office at the latest.

Described above is an explanation based on an exemplary embodiment. The embodiment is intended to be illustrative only and it will be understood by those skilled in the art that various modifications to constituting elements and processes could be developed and that such modifications are also within the scope of the present disclosure.

For example, the acquisition unit 50 of the server device 40 may acquire the traveling route based on road information. The road information includes the position of a blocked road and a period of time elapsed until the road is unblocked. The server device 40 can acquire such road information form a further server (not shown) through wired or wireless communication. The further server refers to a terminal device etc. possessed by a worker to acquire information, entered by the worker, on the period of time elapsed until the road is unblocked and the position of the blocked road. The position of the blocked road may be the position where the road is under repair, the position where an accident is being dealt with, the position where a signal is being in trouble, the position where a fallen object is being removed, the position where a fallen tree is being dealt with, etc.

When it is predicted based on the speed of the vehicle 10 that the vehicle 10 arrives at the position of the blocked road before the period of time elapses, the acquisition unit 50 acquires a traveling route that does not pass the position of the blocked road. When it is predicted that the vehicle 10 arrives at the position of the blocked road after the period of time elapses, the acquisition unit 50 acquires the traveling rotate that passes the position of the blocked road, provided that the traveling route passing the position of the blocked road is the shortest.

According to this variation, the vehicle 10 can travel on an appropriate traveling route even if a road is blocked.

In the case of a task that does not require a transit site, the vehicle 10 may travel from the place of departure to the destination without visiting a transit site.

The processing unit 24 of the vehicle-mounted device 20 may be provided with the acquisition unit 50, the derivation unit 52, and the output unit 54 of the server device 40. The vehicle-mounted device 20 having this configuration functions as an information processing device. In this case; the server device 40 may also be provided with the function of the terminal device 60. The server device 40 may transmit information on the user's task schedule and the user's task situation to the vehicle-mounted device 20 and may receive the task start time, the departure time, and a suggestion for departure in the vehicle 10 output from the output unit of the vehicle-mounted device 20. According to this variation, the flexibility of the configuration of the vehicle system 1 is improved.

What is claimed is:

1. An information processing device comprising:
an acquisition unit configured to acquire a traveling time of a vehicle from a place of departure to a destination, and a period of time required for a task performed by a user;
a derivation unit configured to derive a period of time required for a remaining task in accordance with the period of time required for the task acquired by the acquisition unit and a period of time that the user performed the task; and
an output unit configured to output a suggestion for departure in the vehicle, when the period of time required for the remaining task derived by the derivation unit and the traveling time acquired by the acquisition unit meet a predetermined relationship.

2. The information processing device according to claim 1, wherein
the output unit outputs the suggestion for departure when the period of time required for the remaining task becomes shorter than the traveling time.

3. The information processing device according to claim 1, wherein
the acquisition unit acquires the traveling time from the place of departure to the destination by way of a transit site necessary for the remaining task.

4. The information processing device according to claim 1, wherein
the acquisition unit acquires a desired time of arrival at the destination, and
the output unit outputs a task start time for the task to be completed at the desired time of arrival, based on the period of time required for the task.

5. An information processing method comprising:
acquiring a traveling time of a vehicle from a place of departure to a destination, and a period of time required for a task performed by a user;
deriving a period of time required for a remaining task in accordance with the period of time required for the task acquired and a period of time that the user performed the task; and
outputting a suggestion for departure in the vehicle, when the period of time required for the remaining task derived and the traveling time acquired meet a predetermined relationship.
